(19) United States
(12) Patent Application Publication
(10) Pub. No.: US 2011/0035229 A1
(43) Pub. Date: Feb. 10, 2011

(54) METHOD AND SYSTEM FOR INCORPORATING SERVICE-ORIENTED AUTOMATION COMPONENTS OF A MANUFACTURING FACILITY INTO A FLEXIBLE IT CORPORATE ARCHITECTURE

(75) Inventors: Armando Walter Colombo, Karlstein (DE); Joao Marco Mendes, Ponte de Lima (PT)

Correspondence Address: DENNISON, SCHULTZ & MACDONALD, 1727 KING STREET, SUITE 105, ALEXANDRIA, VA, 22314, US

(73) Assignee: SCHNEIDER ELECTRIC AUTOMATION GMBH, Seligenstadt (DE)

(21) Appl. No.: 12/866,802

(22) PCT Filed: Feb. 16, 2009
(86) PCT No.: PCT/EP2009/051821

§ 371 Date: Oct. 14, 2010

(30) Foreign Application Priority Data
Feb. 14, 2008 (DE) 10 2008 002 771.5

(51) Int. Cl. G06Q 10/00

(52) U.S. Cl. 705/1.1

(57) ABSTRACT

A method for orchestrating and integrating services offered by service-oriented automation components of a manufacturing facility from one manufacturing level to a higher level such as the corporate, business and/or production level. In order to configure flexible production factories in the form of an orchestration process and to specify elements, the service-oriented automation components are coupled to the higher level by way of an orchestration middleware and the services offered by the service-oriented automation components are integrated into the higher level using a vector function and a layout that is based on the orchestration of service-oriented automation components.

The invention relates to a method and a device for the orchestration and integration of services provided by service-oriented automation components from one manufacturing level to a higher level such as the corporate level.

New information technologies have a strong presence in a new generation of manufacturing systems. After years-long parallel development, the paths of the information system tools and of the manufacturing systems are being merged in order to provide an impulse to make the integration of the total business environment possible.

Many attempts have been made to expand the flexibility, usability and integration of holonic and multi-agent systems and high level Petri nets to the new field of service-oriented production systems (Colombo, A. W.; Schoop, R.; Neubert, R.: “An Agent-base Intelligent Control Platform for Industrial Holonic Manufacturing Systems”. IEEE Transaction on Industrial Electronics (IEEE-IES), Vol. 53, No. 1, Cont. 31, February 2006; A. W.: “Industrial Agents: Towards Collaborative Production Automation, Management and Organization”. IEEE Industrial Electronics Society Newsletter, Vol. 52, No. 4, pp. 17-18. December 2005; Colombo A. W. and Schoop, R.: “Collaborative Industrial Automation: Toward the Integration of a Dynamic Reconfigurable Shop Floor into a Virtual Factory”. Chapter XII in “Virtual Enterprise Integration: Technological and Organisational Perspectives (Ed. G. Putnik and M. M. Cunha). Idea Group Publishing, Hershey Pa., USA. March 2005).

Service-oriented architectures for automation devices are described for example in F. Jammes et al.: “Service-oriented architectures for devices—the SIRENA view”, IEEE, INDIN'5, 10-12 Aug. 2005, pages 140 through 147), as well as J. Lastra et al.: “Semantic web services in factory automation: fundamental insights and research roadmap”, IEEE, February 2006, Vol. 2, pages 1 through 11.

One approach to the solution of technical, organizational and financial restrictions lies in looking at a set of production units as a collection of distributed, autonomous and reusable units that work as a set of collaborating units.

Typically, each of these units comprises hardware mechatronics, control software and imbedded intelligence and is capable of communicating with others.

Starting from a functional point of view, each collaborative unit can at any time initiate actions and interact dynamically with others in order to solve local as well as global tasks, taking into account the fact that the units are imbedded within an infrastructure such as a manufacturing corporate environment.

Moreover, analyses have been made with regard to the integration of service-oriented components from the manufacturing level of a plant into the IT corporate architecture in order to facilitate vertical information and control access. According to one possible solution, these components provide the required services to the upper levels of the corporate structure and are thus controllable by the latter. This is compatible with the service-oriented paradigm. However, the conventional master/slave hierarchy of the “top/down perspective” is not advantageous if one talks about collaborative devices acting on their own initiative.

A partial solution is a mixture of autonomous devices from the manufacturing level that can provide services but also request services that are provided by other levels, such as, for example, a decision-making system (DMS), a manufacturing execution system (MES), as well as an enterprise resource planning (ERP) system.

Starting therefrom, the invention at hand is based on the objective of providing a method and a system for the analysis of the operational conduct of autonomous service-oriented automation and production equipment on the manufacturing level, and their integration into a flexible IT corporate architecture.

The objective is to provide a control mechanism of the devices on the manufacturing level showing its own initiative in contrast with the usually more service-oriented factory automation systems in which devices are merely providers of services for higher levels such as DMS, MES and/or ERP.

The idea describes an orchestration middleware for the integration of service-integrated production automation components into a flexible IT corporate architecture. With regard to context, the idea focuses on automation and production systems based on distributed, reconfigurable and service-oriented devices and their integration from one manufacturing level into higher levels (such as corporate/business/production levels). The resulting middleware infrastructure manages and connects the manufacturing site with the higher level using a virtual function and a layout based on the orchestration of devices. All inter-level and intra-level interactions are service-oriented.

The method in accordance with the invention is characterized in particular in that the service-oriented automation components are coupled with the higher level via an orchestrating middleware and that the services offered by the service-oriented automation components are integrated into the higher level with the use of a vectorial function and a layout based on the orchestration of service-oriented automation components.

A preferred embodiment provides for a set of services provided by the service-oriented automation component to be projected into a set of functions/vectors or, respectively, function vectors.

Another procedural method provides for an aggregation of services to occur by assembling the set of functions/vectors or, respectively, function vectors, with a vector space of the service-oriented automation component formed thereby containing all possible individual and aggregated services.

Preferably, the layout of the production site based on the orchestration of service-oriented automation components is configured by assembling the vector spaces of the service-oriented automation components, the generation of restrictions as well as the generation of aggregated services.

In this context it is provided for the vector spaces to represent executable processes that are connected with the services and that are accessed and applied by any higher level having access thereto.

The orchestration middleware can be coupled with external service-oriented components such as production orchestrators and/or decision-making systems. The inter-level interactions as well as intra-level interactions can be executed in service-oriented fashion.

A system for the orchestration and integration of services provided by service-oriented automation components of a production site from a production level of a higher level is characterized in that the service-oriented automation components are coupled via an orchestrating middleware using a vectorial function and a layout based on orchestration of service-oriented automation components.

A preferred system provides for the vectorial function or, respectively, a set of vectorial functions to be projected from a set of services that are provided by the service-oriented automation components and for the function vectors to be assembled into a vector space of the service-oriented automation components for the formation of individual and/or aggregated services. The orchestration middleware is coupled with external service-oriented components such as production orchestrators or decision-making systems.

Additional details, advantages and characteristics of the invention result not only from the claims, from the characteristics contained therein—individually and/or in combination—but also from the following description of embodiments to be found in the drawings.

Shown are:

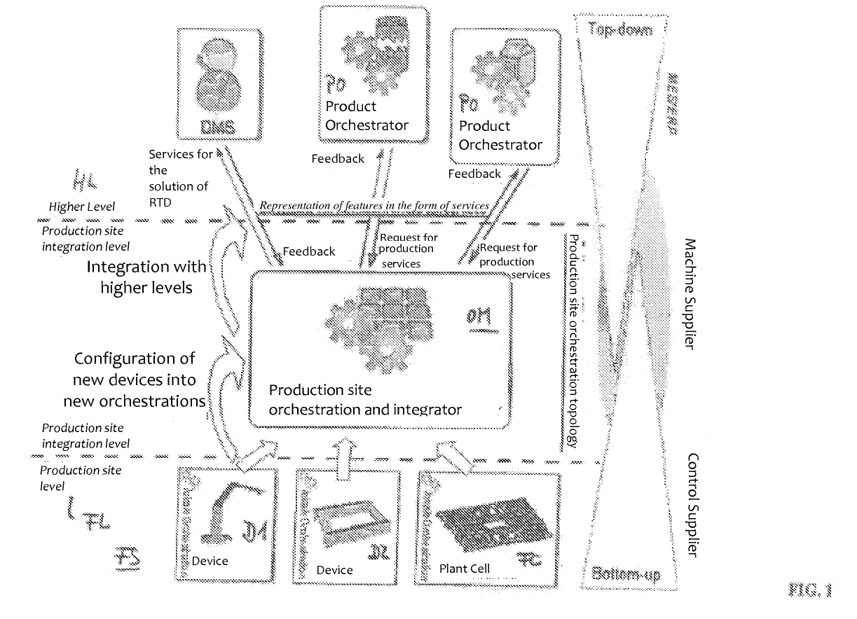

FIG. 1 a schematic representation of an IT corporate architecture with middleware for the orchestration and integration of services of service-oriented automation components of a production site,

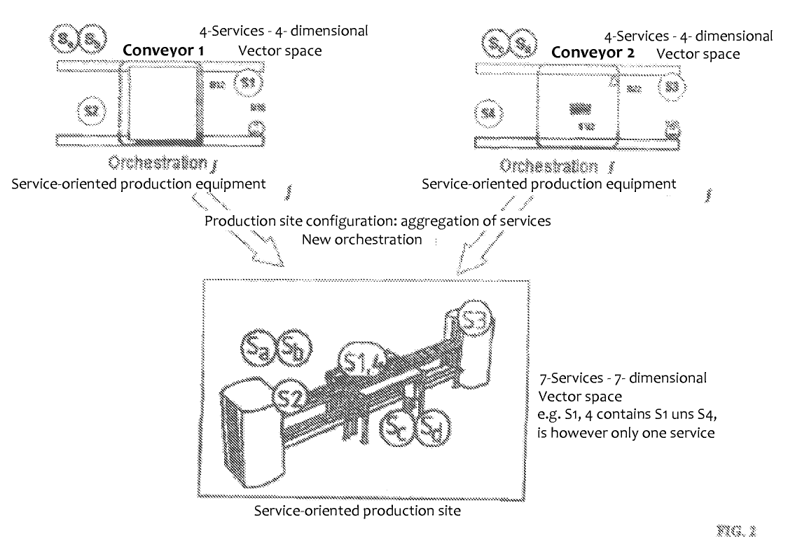

FIG. 2 a schematic representation of the aggregation of two services, and

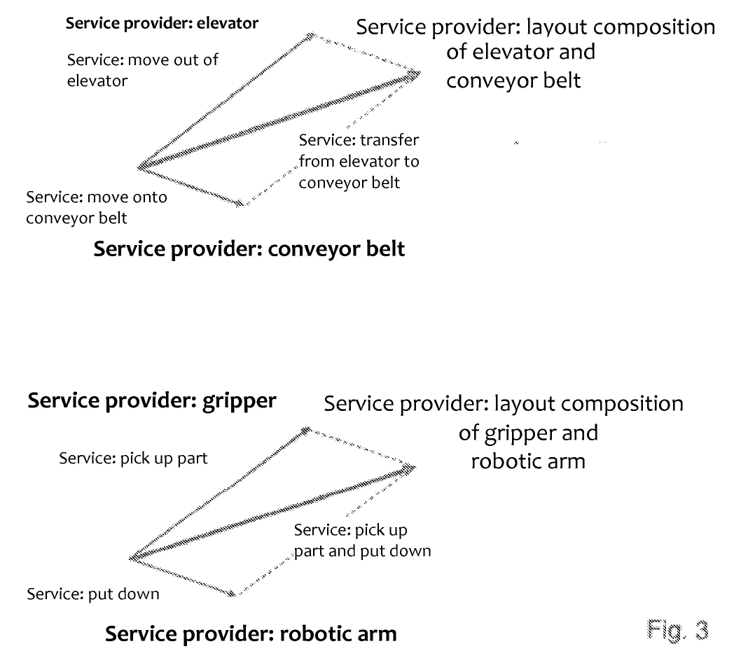

FIG. 3 a schematic representation of the assembly of services by means of vectors.

FIG. 1 shows in purely schematic fashion an orchestration middleware OM that may also be termed production site orchestration and integrator for the integration of service-oriented production automation components D1, D2, FC from one production level into a higher level such as, for example, an IT corporate architecture.

FIG. 1 shows the integration between devices D1, D2, FC of the production site FS and the required interface OM to the higher levels HL in the form of services. These services S represent various and sufficient functionalities of the production site F that are to be led and integrated into the higher level HL and that make a high measure of control and information feedback available. Some of the exposed characteristics of the higher levels HL comprise, without being limited thereto: topology information, maintenance, several control operations, conflict solution, and process analysis and monitoring. The approach is based on a bottom-up perspective (of the devices) in order to adapt the top-down approach from the upper levels HL. There exists a loosely coupled heredity so that the higher levels (often the client side of the middleware OM) are not limited to a specific business activity but to every dependency of the properties of the middleware made available. The idea uses and expands the concept of the service-basedness through the adoption and integration from the device level all the way to the corporate levels HL.

Each production device D1, D2, FC (integrated mechatronics, communication and control aspects) is an orchestrator or, respectively, a process development or, respectively, control that provides services, [to wit] such services that were defined and developed by the device manufacturer. The sequence and combination of services provided by each device follow properties and restrictions generated by the hardware (mechatronics), communication and possible control aspects of the device. The set of services provided by the device can be projected into a set of functions (vectors) as shown in FIG. 3. The combination of function vectors permits the recognition of all possible combinations (aggregation of services) since the vector space of the device contains all possible (permitted) individual and aggregated services.

When a desired layout for a production site is configured, such an action is a form of orchestration. The configuration of a layout implies the composition of devices and of course, formally speaking, the composition of their vector spaces, of the generation of new restrictions and, of course, of a new set of aggregated services. The analysis of the vector space provides all necessary acceptable specifications via the complete set of services that are provided by a given configuration. The vector spaces may also represent executable processes connected with the services that are addressable and manageable by every level that has access to the latter. The integrated behavior of processes that access or, respectively, actuate available services is determined in this way. Processes can be delineated from the automation processes (at the production site), integration processes [and] production processes from the business and corporate processes.

Following the determination of a given layout, a very well defined set of services must be orchestrated or, respectively, defined. It is possible to speak here about the orchestration of the production site.

Putting a layout into operation implies that the sequence of accessed services respects mechatronics, communication and control specifications/properties/restrictions such as jointly used resources, process capacity, competitors, etc. that are explicitly contained in the topology of the aggregated service.

The orchestration topology for a given automation/production system can now be coupled with external service-oriented components, such as, for example, product orchestrators PO and decision-making systems (DMS). For example, the orchestration middleware OM may provide the decision-making systems DMS services for the solution of real-time decisions.

For example, a defined operating cycle linked with a product may be able to access services (individual or aggregated ones) that are provided to the production site FS by the orchestration topology only if and when the right interface exists, and the orchestrator PO linked with the product will recognize what services are to be found in the orchestration topology of the production sites.

The main result of this approach is that the orchestration topology of the production sites works as a system integrator integrating SOA-based production sites with other SOA-based components of an IT corporate architecture (see FIG. 1):
integrated service-oriented production devices (mechatronics, control and communication) (control provider+machine provider)
integrated production site with higher levels such as, for example, production management systems (control provider+MES (manufacturing execution system)/ERP (corporate resource and planning system)).

The application example according to FIG. 2 shows how the configuration of the production site is designed in the form of an aggregation of services and the resulting orchestration. The two devices, conveyor 1 and conveyor 2, each have 4-dimensional vector spaces that are projected in 4 corresponding services. In particular, conveyor 1 makes services SA, Sb, S1, S2 available, and conveyor 2, services Sc, Sd, S3 and S4. Services S1, S2, S3 and S4 represent the necessary interface that manages the input and output transfer services for each conveyor. When the conveyors are linked and aggregated with regard to mechatronics, communication and control, the resulting dimension is 7, and consequently the new configuration provides the production site 7 services. A special case is the aggregation of services S1 and S4 in one single service S1,4 since they represent a dependent logic: the transfer-out operation of service 51 needs the transfer-in operation of S4. The new service S1,4 and the other non-dependent services are part of the new 7-dimensional vector space.

The invention makes it possible to configure flexible production sites in the form of an orchestration process and to specify elements in order to develop the middleware for a transparent integration of production site components (such as devices) that are specified by their services in an SOA-based IT corporate architecture.

Complementary remarks: The approach utilizes concepts of service orientation for the expansion of the adaptation and integration from the device level up to the corporate level. Several advantages can be clearly seen from this idea. On the one hand, the “inherited” characteristics of service-oriented architectures are merged with traditional configuration approaches for production sites and, on the other hand, a new and innovative orchestration approach that is formally based on the theory of vector analysis.

### Initial Summary of Advantages:

orchestration and integration of middleware that provides high-level, feature-full and methodologically independent control, transparent view, access and management on the production level;
reuse of service-oriented concepts on all levels, provision of an integration architecture;
advantages for management, particularly the combined access to the production site;
reconfiguration at the production site does not require a corresponding configuration at the higher levels (and vice versa);
reusability of services for any purpose;
collision management of bottom-up and top-down views through middleware;
use of mathematical methods and bases (such as, for example, linear algebra and functional analysis) for the specification, analysis, validation and support of the real-time behavior of the systems modeled with Petri nets.
   In the above text, the following terms are used as follows:

Orchestration describes the automatic assembly, coordination and management of services. The orchestration process is carried out by a participant (service/service providers/owners) called orchestrators.

Orchestration describes in general terms an executable production or business process; in this case, in-house as well as external services may be orchestrated. The process flow is controlled by a participant.

In computer science, middleware is the term for application-neutral programs that mediate between applications in such a way that the complexity of these applications and of their infrastructure is concealed. Middleware may also be regarded as a distribution platform, i.e. as a protocol (or protocol bundle) on a higher level than the common computer communication. In contrast with lower-level network services handling simple communication between computers, middleware supports the communication between processes. Middleware connects software components, thereby supporting the interoperability between the aforementioned components.

Service-oriented architecture (SOA): SOA is a paradigm for the structuring and utilization of distributed functionality that different services/service owners/participants are accountable for.

SOA is an approach of information technology from the area of distributed systems in order to structure and utilize services of production equipment.

A set of functions (vectors) or, respectively, function vectors may be understood as a description of functionalities/abilities/restrictions of the devices/components and the relationships between the aforementioned functionalities in the form of linear equations. Each function may also be identified as a basic vector of a vectorial field. In general, the number of basic vectors forms a vectorial field. If these functions describe services, we will have a vectorial field of services.

As in all vectorial fields, the composition of basic vectors yields new vectors (with the same number of coordinates/dimensions as the field). Since the vectors describe functions, the following projection results: these complex functions may be the mathematical result of service relationships and may be further composed in order to generate even more complex functions as shown in FIG. 3.

1. Method for the orchestration and integration of services provided by service-oriented automation components of a production site from one production level to a higher level such as the corporate, business and/or production level, with the service-oriented automation components being coupled with the higher level via an orchestration middleware and the services provided by the service-oriented automation components being integrated into the higher level using a vectorial function and a layout based on the orchestration of service-oriented automation components.

2. Method in accordance with claim 1,
characterized in
that a set of services provided by the service-oriented automation component is projected into a set of functions/vectors or, respectively, function vectors.

3. Method in accordance with claim 1 or 2,
characterized in
that an aggregation of services occurs through a composition of the set of functions/vectors or, respectively, function vectors, with a vector space of the service-oriented automation component formed therefrom containing all possible individual and aggregated services.

4. Method in accordance with at least one of the preceding claims
characterized in
that the layout of the production site based on orchestration of service-oriented automation components is configured through composition of the vector spaces of the service-oriented automation components, generation of restrictions as well as generation of new sets of aggregated services.

5. Method in accordance with at least one of the preceding claims
characterized in
that the vector spaces represent executable processes that are connected with the services and that are accessed and used by those higher levels that have access to them.

6. Method in accordance with at least one of the preceding claims
characterized in
that the orchestration middleware is coupled with external service-oriented components such as production orchestrators and/or decision-making systems.

7. Method in accordance with at least one of the preceding claims
characterized in
that inter-level interactions as well as intra-level interactions are executed in service-oriented fashion.

8. System for orchestration and integration of services (S) provided by service-oriented automation components (D1, D2, FC) of a production site (FS) from one production level (FL) into a higher level (HL) such as corporate, business and/or production level,
characterized in
that the service-oriented automation components (D1, D2, FC) are coupled via an orchestration middleware (OM) using a vectorial function and a layout based on orchestration of service-oriented automation components.

9. System in accordance with claim 8,
characterized in
that the vectorial function or, respectively, a set of vector functions is projected from a set of services (S) provided by the service-oriented automation component (D1, D2, FC) and that the function vectors are assembled to a vector space of the service-oriented automation component (D1, D2, FC) to form individual and/or aggregated services (S).

10. System in accordance with claim 8 or 9,
characterized in
that the orchestration middleware (OM) is coupled with external service-oriented components such as production orchestrator (PO) and/or decision-making systems (DMS).
